(19) United States
(12) Patent Application Publication
(10) Pub. No.: US 2024/0317548 A1
(43) Pub. Date: Sep. 26, 2024

(54) METHOD FOR INDIRECTLY DETERMINING AN EXTENSION LENGTH OF AT LEAST ONE TELESCOPIC PUSH ARM OF A TELESCOPIC JIB

(71) Applicant: Palfinger AG, Bergheim bei Salzburg (AT)

(72) Inventors: Alexander MAYRDORFER-SCHINDLAUER, Ostermiething (AT); Thomas Deimer, Moosdorf (AT)

(21) Appl. No.: 18/680,194

(22) Filed: May 31, 2024

Related U.S. Application Data
(63) Continuation of application No. PCT/AT2022/060405, filed on Nov. 18, 2022.

(30) Foreign Application Priority Data
Dec. 2, 2021 (AT) GM 50240/2021

(51) Int. Cl. B66C 13/46; B66C 23/70; G01B 21/02

(52) U.S. Cl. CPC B66C 13/46; G01B 21/02; B66C 23/701

(57) ABSTRACT

A method for indirectly determining an extension length of a telescopic push arm of a telescopic jib relative to a further telescopic push arm or to a main arm of the telescopic jib of a hoist includes a first sensor ascertaining a first parameter of the telescopic push arm and/or telescopic jib. On the basis of the first parameter, a first virtual extension length is determined and/or calculated. The first sensor and/or at least one further sensor ascertains a further parameter of the telescopic push arm and/or telescopic jib. On the basis of the further parameter, a further virtual extension length is determined and/or calculated. The extension length of the telescopic push arm or the telescopic jib is determined and/or calculated by the first virtual extension length and the further virtual extension length.

The present application is a continuation of International Application PCT/AT2022/060405 filed on Nov. 18, 2022. Thus, all of the subject matter of International Application PCT/AT2022/060405 is incorporated herein by reference.

### BACKGROUND OF THE INVENTION

The invention relates to a method for indirectly determining an extension length of at least one telescopic push arm of a telescopic jib relative to a further telescopic push arm and/or to a main arm of the telescopic jib, in particular at least part of the telescopic jib, of a hoist. The invention furthermore relates to a computer program product. In addition, the invention relates to a hoist comprising at least one telescopic push arm and/or at least one telescopic jib, at least one first sensor, which is different from a possibly present direct extension length sensor, possibly at least one further sensor, which is different from a possibly present direct extension length sensor, and at least one control and/or regulating apparatus.

Conventional hoists from the state of the art usually use a measuring cable in order to directly determine the extension length of the telescopic jib. However, the costs of measuring cables are substantial and, in particular because of the exposed position of the measuring cable on telescopic push arms, the measuring cable is exposed to environmental influences such as weather, as a result of which the service life of the measuring cable is limited and installation and/or maintenance work is complex, in particular in connection with a cable guide of the measuring cable. Moreover, the measuring cable is often not to be integrated in the hoist due to lack of space and there is also the risk that the measuring cable will tear and/or fall out of the cable guide in the case of this manner of determining the extension length, as a result of which the functionality of the hoist is severely restricted. Moreover, the measuring cable must be permanently pretensioned for proper operation.

A method for indirectly determining the extension length is already known from the document DE 10 2019 211 880 A1. In that method, a current cylinder volume value is ascertained by reference to an amount of hydraulic fluid supplied to or discharged from a pressure chamber of a hydraulic cylinder, and a current value of the extension length can be deduced by virtue of the cylinder volume value. However, in practice, determining the extension length on the basis of hydraulic fluid movements is not enough in order to be able to guarantee a sufficiently exact ascertaining of the extension length, in particular as a plurality of influencing variables-such as pressure, temperature, viscosity et cetera—feed into the determination of the extension length, and a high degree of precision of the currently existing extension length is necessary in order to be able to supply it for example to convenience functions of the hoist for reliable calculations. In addition, an absolute error quickly accumulates into large deviations as the inaccuracies are permanently added together as an incremental error.

### SUMMARY OF THE INVENTION

The objective technical problem of the present invention is therefore to specify a method for indirectly determining an extension length that is improved compared with the state of the art and a hoist, in which the disadvantages of the state of the art are at least partially remedied and which are characterized in particular by being usable even in the case of hoists with limited installation space, wherein an accurate and reliable value of the extension length can also be provided to complex convenience functions without the need for measuring cables or the like.

It is therefore provided according to the invention that the following method steps are carried out:
at least one first sensor, which is different from a possibly present direct extension length sensor, ascertains at least one first parameter of the at least one telescopic push arm and/or telescopic jib, in particular over a time interval, wherein a first virtual extension length is determined and/or calculated via the at least one first parameter, preferably via a physical model,
the at least one first sensor and/or at least one further sensor, which is different from a possibly present direct extension length sensor, ascertains at least one further parameter of the at least one telescopic push arm and/or telescopic jib, in particular over a time interval, wherein at least one further virtual extension length is determined and/or calculated via the at least one further parameter, preferably via a physical model,
the extension length of the at least one telescopic push arm or of the telescopic jib is determined and/or calculated by the first virtual extension length and the at least one further virtual extension length.

It is thereby made possible for the first time that the extension length can be ascertained without a sensor system for directly determining the extension length. Added to this is the positive property that the extension length can be determined very precisely, as the extension length can be determined via at least two virtual extension lengths-based for example on calculations of different underlying physical models. The method can be used flexibly in a wide variety of structural designs of hoists, in particular to reduce the installation space required.

A hoist can represent, for example, a telescopic implement with a work cage or, for receiving containers and/or for moving loads, with a load sling. The hoist particularly preferably represents a machine such as for example a crane, a mobile elevating work platform or a crane boom.

The parameter ascertained by the sensor can represent for example a sensor signal or a variable derived therefrom, wherein the derived variable is preferably calculated, and/or is determined via a physical model. The parameter can generally be ascertained in a time-discrete or time-continuous manner. The extension length can also be ascertained in a time-discrete or time-continuous manner, in particular in dependence on the sensors and/or physical models involved.

For example, a coordinate control represents a convenience function for the hoist, which can be implemented with the aid of such a method, in order to be able to control exact vertical or horizontal travels of the telescopic jib in a user-friendly manner. Moreover, the method is also applicable in the case of stability and/or overload protection concepts, wherein standard specifications with respect to safety aspects can in particular be taken into account. In particular, however, costs for non-safety-related convenience functions (such as assistance functions for enhancing performance) are saved, and installation and maintenance work is reduced, as the ascertaining of the extension length can be effected by reference to physical models. The present invention is in addition flexibly implementable in a broad spectrum of widely different hoists and, as a rule, usable with a sensor system already present on the hoist, without having to structurally redesign the hoist.

The at least one first sensor and the at least one further sensor can be regarded as virtual sensors with respect to detecting the extension length, which differ from a direct extension length sensor for directly determining the extension length, taking into consideration underlying physical models, which are in each case different from each other, for the further processing of the sensor signals and/or variables derived therefrom. Examples of such direct extension length sensors can in this context represent GPS, laser, lidar, radar, cameras, measuring cables, potentiometers, magnetic tape encodings, inductive or magneto-resistive length measurement sensor systems or the like, wherein the at least one first sensor and the at least one further sensor in each case allow the extension length to be inferred indirectly.

A first telescopic push arm associated with the virtual extension length is not restricted to an innermost or outermost telescopic push arm, but rather can represent any telescopic push arm of the telescopic jib. The extension length is defined as a telescoped-out length of a telescopic push arm, a portion of the telescopic jib or the telescopic jib (in particular currently existing or accumulated starting from a predefined value). The main arm is defined in this context to the effect that it represents the telescopic push arm of the telescopic jib which is closest to a crane column, and preferably cannot be telescoped, wherein the telescopic push arm closest to the telescopic jib can be telescoped from the main arm.

The main arm can be identified as an articulated arm or a crane boom, which in particular cannot be telescoped, wherein the crane boom connected upstream of the articulated arm or telescopic jib which can be telescoped—for example in the form of a crane column or a crane boom closest to the crane column—can generally also be defined as the main arm, wherein the virtual extension length of the telescopic jib can be ascertained starting from any desired reference point.

As stated at the beginning, protection is also sought for a computer program product comprising commands which, when executed by a computing unit, prompt the latter to perform a method according to at least one of the preceding claims from a storage unit which is in or can be brought into data connection with the computing unit.

The computing unit and/or the storage unit can for example be comprised by a control and/or regulating apparatus of the hoist—for example in the form of a module—or be in signal-carrying connection therewith. The control and/or regulating apparatus can perform the calculation of the extension length—for example via an algorithm and with the aid of physical models.

As stated at the beginning, protection is also sought for a hoist comprising at least one telescopic push arm and/or at least one telescopic jib, at least one sensor, which is different from a possibly present direct extension length sensor, possibly at least one further sensor, which is different from a possibly present direct extension length sensor, and at least one control and/or regulating apparatus, wherein the control and/or regulating apparatus is formed to carry out such a method.

The method is also applicable in the case of a plurality of hoists such as cranes, wherein the ascertained extension lengths of telescopic jibs of individual cranes are compared with each other in order to coordinate shared movement sequences. In particular, a tandem lift with a plurality of cranes can be effected particularly favorably with the method. Movements for several telescopic jibs which are different from each other on one hoist can also be carried out, preferably simultaneously, particularly favorably via the method, wherein different physical models, varying quality classes or values and/or different weightings can in particular be used for ascertaining the virtual extension length.

According to an advantageous design of the invention, the first virtual extension length and/or the at least one further virtual extension length is weighted. Preferably, the weighting:
is present in the form of a predefined static weighting value, and/or
is determined and/or calculated via a history of the first virtual extension length and/or the at least one further virtual extension length, and/or
is determined and/or calculated by a statistical evaluation of the first virtual extension length and/or the at least one further virtual extension length, and/or
is determined and/or calculated in dependence on a quality class and/or a quality value of the first virtual extension length and/or the at least one further virtual extension length, and/or
is determined and/or calculated in dependence on a predefined and/or definable weighting parameter.

The weighting is generally different for virtual extension lengths which are ascertained taking into consideration different physical models and/or different underlying parameters recorded via the at least one sensor and/or the at least one further sensor. However, the weighting can also change for a virtual extension length if for example an operating parameter of the hoist which has an influence on the calculation of the virtual extension length changes. Examples of weighting parameters can represent, among other things, a quality class, a quality value, type of the hoist, design of the hoist, number of telescopic jibs and/or telescopic push arms, number of telescopic push arms per telescopic jib, type of the sensors and/or parameters, number of physical models and/or virtual extension lengths used, requirements (for example with respect to accuracy, dynamics, errors, etc.) and/or intended use of the extension length, changes in the quality class/quality value, differences between virtual extension lengths et cetera.

For example, fixed or predefined weighting parameters can be used for the calculation of the virtual extension length. An ascertaining of the virtual extension length can generally also be effected on the basis of definable weightings or weightings determined via predefinable weighting parameters. Various parameters, such as embodiment, configuration or the like, of the hoist and/or further influencing factors can feed into the weighting.

A quality class can represent, for example, a categorization of the virtual extension length with respect to a precision and/or reliability. A quality value can represent for example a numerical value with respect to the precision and/or reliability of the virtual extension length. A classification of the quality of the virtual extension length depending on the respectively underlying physical model can thereby be obtained. For example, a preferably current error probability, known uncertainties of the respective physical model et cetera can feed into the physical model. Quality class and quality value can alternatively or additionally be used in the determination of the extension length.

The history can generally comprise preceding movements of the hoist and/or digital recordings of preceding extension lengths and/or virtual extension lengths.

Other weighting factors are generally possible as an addition and/or as an alternative depending on the requirement placed on the hoist and/or the area of application of the hoist. The weighting factors can also be adapted depending on a desired accuracy of the extension length.

The quality classes/quality values particularly preferably interact with the weightings, wherein for example according to a feedback mechanism a changed quality class has repercussions on the weighting and adapts it.

It is advantageously provided that at least one of the following criteria is taken into consideration in the weighting: a hoist type, an embodiment of the telescopic jib, a number of telescopic push arms and/or telescopic jibs, a type of the at least one first sensor and/or of the at least one further sensor, a type of the at least one first parameter and/or of the at least one further parameter, a number of parameters used, a current operating position of the telescopic jib, requirements placed on the extension length, intended use of the extension length, operating parameters of the hoist.

The weighting can generally be used both in the case of dynamic and in the case of static and statistical calculations of the extension length. Operating parameters can represent, for example, a currently existing temperature or a currently existing pressure.

By type of the parameter is meant that the parameter (possibly as a sensor signal or a derived variable) can be present, for example, in the form of an oscillation parameter such as frequency or amplitude, a pressure parameter, a fill level value, a volumetric flow rate, a position such as a diaphragm position or slide valve position, a rotational speed and/or a combination of parameters, and the underlying physical models for determining the extension length can differ in terms of complexity and/or accuracy. A weighting of the virtual extension lengths, which allows for this circumstance, can be performed depending on the present parameters. The parameter can generally also be present as derived variables, wherein for example an oscillation, from which a frequency can be inferred as a parameter, is recorded by the sensor. The parameters can generally also be combined with influencing variables such as pressure, temperature, tilt or geometry of the hoist or the like.

It has proved to be favorable that the weighting is adjusted during operation of the hoist, preferably of the telescopic jib and/or dynamically in each sampling cycle of a, preferably mobile, control and/or regulating apparatus.

This makes it possible to guarantee a use and/or visualization of the extension length precisely with a particularly high temporal resolution. For example, quality values/quality classes can also be adjusted dynamically for ascertaining the extension length. Operating parameters can generally change in the case of an actuation of actuators of the hoist, which are in particular not directly associated with the extension length of the telescopic jib or further actuators. The virtual extension length is constantly adjustable, even if the telescopic jib is not actively telescoped per se at this point. A change in the extension length as a result of the method can be monitored, limited, made possible and/or prevented using target values for the telescopic jib.

The following aspects can be taken into consideration in the case of an ongoing change in weightings:
changes in quality values and/or quality classes,
difference between the extension length and a virtual extension length, wherein deviations result in particular in a changed quality value/quality class,
relationship between quality classes/quality values and deviations between virtual extension length and extension length, and
significant trends in a virtual extension length of a specific physical model/parameter, in particular for detecting possible discrepancies in the calculation and/or undesired operating states.

According to an advantageous embodiment of the invention, the first virtual extension length and/or the at least one further virtual extension length is classified, preferably into quality classes and/or by a quality value. Preferably, a quality class and/or a quality value of the extension length is determined and/or calculated.

For example, because of a specific error-proneness of the underlying physical model, component tolerances, measurement inaccuracy and/or operating parameters in the respective application, a quality of a virtual extension length can differ from virtual extension lengths based on differentiated parameters and/or for determining physical models used. The classification via quality classes and/or quality values can be used for example in order to weight virtual extension lengths differently and/or to use the virtual extension lengths that have a particularly high precision for the calculation of the extension length.

A quality of the physical model and/or a quality of the parameter of the sensor for determining the virtual extension lengths can feed into the classification of the virtual extension lengths into quality classes and/or by quality values, wherein error probabilities, known uncertainties or the like are particularly preferably taken into consideration.

It has proved to be advantageous that the quality class and/or the quality value is adjusted during operation of the hoist, preferably of the telescopic jib and/or dynamically in each sampling cycle of a, preferably mobile, control and/or regulating apparatus. Preferably, the quality class and/or the quality value:
of the first virtual extension length and/or of the at least one further virtual extension length is adjusted in dependence on at least one of the following criteria: an operating position of the telescopic jib, a possibly present weighting, a history of a hoist movement, a duration of a telescoping movement, further hoist movements, operating parameters of the hoist, and/or
of the extension length is adjusted in dependence on, preferably the quality class and/or the quality value of, the first virtual extension length and/or on, preferably the quality class and/or the quality value of, the at least one further virtual extension length.

Further hoist movements are to be understood here as movements of the hoist to be distinguished from telescoping movements, such as changes in geometry and/or articulation movements. For example, temperature, pressure, viscosity of hydraulic oil, changes in a tilt due to changes in geometry, a telescopic jib geometry, a hoist geometry, an operating position of the telescopic jib, a load mass arranged on the telescopic jib or the like in relation to the hoist are comprised by the operating parameter.

An influencing variable for the quality class and/or the quality value particularly preferably represents a margin of error of the virtual extension length and/or a buffer value of a difference between at least two virtual extension lengths.

An advantageous variant is that at least one margin of error, preferably taking into consideration a possibly present weighting, is determined and/or calculated for the first virtual extension length, the at least one further virtual extension length and/or the extension length.

A user and/or a control and/or regulating apparatus can thereby particularly favorably estimate to what degree the extension length has been correctly determined or is reliable.

The margin of error can be used in order to define a weighting of the virtual extension lengths and/or a quality class or a quality value of the virtual extension length. The margin of error can generally result from the underlying physical model and/or be calculated for example by means of Gaussian error propagation from tolerance values in the determination of the virtual extension length. Differences from virtual extension lengths can be taken into consideration via a buffer, in order to harmonize the buffer successively over the virtual extension lengths and/or to adjust virtual extension lengths of lower quality classes and/or quality values or the extension length successively/constantly.

The extension length ascertained using the method can (and is to) represent—in particular for the further processing-a constant variable. Discrete physical models for determining the virtual extension length can also be converted via the buffer into constant extension lengths and/or virtual extension lengths. However, the constancy of the extension length and/or of the virtual extension length need not necessarily be generated by the buffer.

It is particularly preferred that the first virtual extension length, the at least one further virtual extension length and/or the extension length, preferably together with at least one possibly present margin of error, are visualized via a visualization device.

An operator of the hoist can thereby recognize at a glance what extension length is currently present, without underlying direct measurement methods and/or necessary reproduction of complex interactions.

In an embodiment of the invention, the first virtual extension length, the at least one further virtual extension length, and/or the extension length is determined and/or calculated in a substantially time-continuous or time-discrete manner.

A combination of time-continuous and time-discrete determination is also conceivable, wherein the method can be flexibly adjusted to conditions of the hoist and/or to requirements placed on the hoist.

In addition or as an alternative, the virtual extension lengths and/or the extension length can be used in a control and/or regulating apparatus for further use in order for example to be used in calculations with respect to convenience functions and/or during the execution of convenience functions of the hoist.

According to a preferred embodiment of the invention, in no working cycle of the hoist and/or at no time is the extension length determined and/or calculated exclusively via the first virtual extension length.

As the extension length is ascertained at least via two virtual extension lengths, fluctuations in individual virtual extension lengths are compensated for and the accuracy of the extension length can be guaranteed to a high degree by error reduction.

An extension and/or a retraction of the at least one telescopic push arm can for example be defined as a working cycle.

It has proved to be favorable that the first virtual extension length, the at least one further virtual extension length and/or the extension length is determined and/or calculated taking into consideration at least one additional parameter, preferably at least one of the following additional parameters: a telescopic jib geometry, a hoist geometry, an operating position of the telescopic jib, a load mass arranged on the telescopic jib, an operating parameter of the hoist, a history of a hoist movement, a current hoist movement, operating states of hydraulic consumers of the hoist, a duration of a telescoping movement.

Quality classes and/or quality values, margins of error and/or buffer values of the virtual extension length are particularly preferably taken into consideration in the determination of the extension length.

An algorithm for calculating the extension length can be particularly favorably expanded by bringing in further criteria and/or further parameters, without having to modify the hoist structurally.

Furthermore, preferably the at least one telescopic push arm comprises a hydraulic drive unit with at least one diaphragm, and the at least one diaphragm comprises a plurality of diaphragm positions for controlling a hydraulic oil flow in the hydraulic drive unit. The at least one parameter in the form of a current diaphragm position is ascertained by the at least one first or the at least one further sensor, and a volumetric flow rate in the hydraulic drive unit is deduced using the at least one parameter, preferably via a physical model.

The transition from a sensor signal or a variable derived on the basis of the sensor signal to the virtual extension length is generally effected via a physical model.

The diaphragm can be realized in this context, for example, via a slide valve rod or a load holding valve. A current valve position can be measured for example via a position sensor, and the total volume in the hydraulic cylinder and therefore the cylinder stroke are inferred from accumulation of volumetric flow rate over a time interval. The use of volumetric flow rate characteristic curves, which are possibly adaptable via further physical models, is likewise possible, wherein a pressure difference can generally be assumed as constant. In addition, it is possible to take into consideration for example a distinction between sequence-controlled and non-sequence-controlled cylinders or a reinitialization of a volumetric flow rate model by virtue of measurement results and/or results of physical models with regard to other virtual extension lengths.

The calculation on the basis of this physical model has the advantage that the calculation of the virtual extension length can be effected in a time-continuous manner, and dynamic processes, such as change in telescopic push arm speeds, are accurately depicted. Moreover, the determination of the virtual extension length of several telescopic systems on one device is possible.

The quality value/the quality class of this process for determining the virtual extension length can be dependent on a temperature of hydraulic oil, an angular position of the telescopic jib, a speed of the telescopic push arms in question, an ambient temperature, a load mass arranged on the telescopic jib, valve positions, time intervals, sequence control mechanisms et cetera. In particular, the speed can represent a target speed of the telescopic push arms in question or a speed prespecified by an operator of the hoist (for example of the telescopic push arms in question), as an actual speed of the telescopic push arm is generally not known.

Furthermore, preferably the at least one telescopic push arm comprises a hydraulic drive unit with at least one position-dependent diaphragm. A flow of hydraulic oil in the hydraulic drive unit can be controlled via the at least one diaphragm, and the at least one parameter in the form of a position of the at least one diaphragm and/or a pressure difference at the at least one diaphragm is ascertained by the at least one first or the at least one further sensor. A volumetric flow rate in the hydraulic drive unit is deduced using the at least one parameter, preferably via a physical model.

The position-dependent diaphragm can be implemented, for example, as a slide valve rod of a slide valve, and volumetric flow rate values can be calculated for each position, each pressure difference and/or each density factor of the hydraulic oil. Density factors can be determined, among other things, via temperature sensors and pressure sensors and are in turn dependent on operating parameters of the hoist. The virtual extension length can be inferred from integration of volumetric flow rate per time unit, wherein a calibration of volumetric flow rate values can be carried out for example in the case of pressure changes, temperature changes or also in the case of detection of an end position of a telescopic push arm.

The calculation on the basis of this physical model has the advantage of time-continuous calculation, accurate depiction of changes in speed of telescopic push arms, exact calculation in the case of high load pressures, and possible use in the case of a plurality of telescopic systems. The quality values/quality classes can be chosen for example in dependence on a pressure difference at the position-dependent diaphragm and/or temperature values.

Furthermore, preferably the at least one telescopic push arm comprises a hydraulic drive unit with a hydraulic oil tank for supplying hydraulic oil to the hydraulic drive unit, and the at least one parameter in the form of a fill level of the hydraulic oil tank is ascertained by the at least one first or the at least one further sensor. Preferably, further hydraulic drive units connected to the hydraulic oil tank are taken into consideration, preferably via a physical model.

Via a tank fill level of hydraulic consumers, a volume which is used for the filling with respect to telescopic push arms can be calculated and the virtual extension length can be inferred, wherein deviations of the fill level in the case of tilting, sloshing or the like can be compensated for (for example by a tilt sensor system). As an absolute calculation of the volume is made possible starting from a final (re) initialization, accumulation errors can be prevented. Quality values/quality classes can be defined in dependence on a tilt of the hydraulic oil tank, temperature changes et cetera.

Furthermore, preferably the at least one telescopic push arm comprises a hydraulic drive unit with a piston cylinder unit. The at least one parameter in the form of a natural frequency of the at least one telescopic push arm and/or of the telescopic jib is ascertained on the piston cylinder unit, preferably via a physical model, by the at least one first or the at least one further sensor.

Here, for example, the sensor measures a pressure oscillation as a sensor signal, using which the natural frequency can be ascertained as a parameter via a physical model for ascertaining the natural frequency and/or for determining the virtual extension length as a derived variable.

Through a telescoping process, a pulse can be induced in the case of the telescopic jib, which results in a free oscillation which continues in the telescopic push arms and can be measured via pressure sensors. This pulse is not generated artificially, in order to be able to carry out a measurement. For example, an absolute position of the telescopic push arm, or the interaction between absolute positions of the telescopic push arm, can be inferred from known conditions such as natural frequency, load mass, mass of the telescopic jib and/or flexural strengths. The natural frequency and total mass are ascertained empirically and stored as a characteristic curve, which can be used to determine the virtual extension length.

Variable stiffnesses, effects of the load mass on the natural frequency, compressibility values of hydraulic oil and the like can be taken into consideration in the calculation of the virtual extension length on the basis of this physical model. An absolute ascertaining of the entire radius is also made possible in the case of the use of a plurality of telescopic push arms and is favorably applicable in case particularly the of small longitudinal extents of telescopic jibs. Criteria for the quality values/quality classes can represent for example an angular position of the telescopic jib, the existing natural frequency, amplitudes of the pressure oscillation, an actuation of valves according to a pulse detection of the pulses of the telescopic jib occurring in the course of the telescoping. Pulses during operation can be detected, and thus used to ascertain the extension length. A weighting can be effected in an analogous approach.

Further, preferably the at least one telescopic push arm comprises a hydraulic drive unit with a piston cylinder unit. The at least one parameter in the form of an oscillation amplitude of the at least one telescopic push arm and/or of the telescopic jib is ascertained on the piston cylinder unit, preferably via a physical model, by the at least one first or the at least one further sensor.

Here, the sensor measures for example a current pressure value as a sensor signal, and the pressure curve and the oscillation amplitude in the form of a derived variable are evaluated as parameters via a physical model. A cause of the pressure curve can be for example a pressure surge in the case of an opening or closing process of a valve.

In the case of a process of telescoping out or in, a hydraulic valve generally opens during the transition of hydraulic cylinders, and thereby causes a (negative) hydraulic pressure surge/pressure equalization, which continues in the telescopic jib and is reflected in order then to reach the valve again. The hydraulic valve is preferably present in the form of a sequence control valve in the case of sequence-controlled telescopic jibs, and proportional valves and/or black-white valves can generally be used. Via a pressure difference of the pressure surge, a residual length of unextended telescopic jibs and therefore the virtual extension length can be inferred—for example via a current position of telescopic push arms. In particular, in the case of sequence-controlled telescopic jibs, the current position is unambiguous. Dependencies as such pressure differences, closing/opening times of valves or densities/changes in speed of hydraulic oil can be taken into consideration. The pressure surge can be measured via a pressure sensor, wherein the virtual extension length can be particularly favorably calculated absolutely.

Quality values/quality classes and weightings can be defined on the basis of speeds and volumetric flow rates of hydraulic oil in the telescopic push arm, the use of sequence control mechanisms, temperatures and/or pressures of hydraulic oil.

Furthermore, preferably the at least one telescopic push arm comprises a hydraulic drive unit with a piston cylinder unit. The at least one parameter in the form of an extreme value of a pressure in the piston cylinder unit is ascertained by the at least one first or the at least one further sensor, preferably via a physical model.

Here, the sensor measures, for example, a currently existing pressure value as a sensor signal, and the extreme value in the form of a derived variable in the form of the parameter can be ascertained via a physical model. Here, via the physical model, the pressure curve can be examined for discontinuities and/or with regard to pressure gradients which can be causally determined for example in the case of a transition of a telescoping movement from one telescopic push arm to a further telescopic push arm.

A deceleration or acceleration of the telescopic push arms involved is caused by a transition from a telescopic push arm to a following one. Typical pressure peaks and/or pressure drops, which can be measured for example directly in a supply line of a telescopic push arm, are effected temporarily because of a mass inertia and hydraulic effects, such as throttling or an actuation of sequence control valves. The use of existing pressure sensor systems is likewise conceivable. A particularly small number of parameters for determining the virtual extension length is necessary as for example no reference point is needed for the calculation. The quality class/the quality value can be dependent on an unambiguousness of a pressure curve, pressure gradients, hydraulic oil viscosities, temperatures, number of preceding transitions, extension speed et cetera.

Further, preferably the at least one parameter in the form of a lifting moment is ascertained by the at least one first or the at least one further sensor, preferably via a physical model.

Here, the sensor measures the pressure for example, and the lifting moment can be determined via the physical model as a parameter in the form of a derived variable for calculating the virtual extension length (via geometry dependencies).

In the case of a known angular position of the telescopic jib, the virtual extension length can be particularly favorably deduced by virtue of different moment curves of intrinsic moments and/or load moments. A current lifting moment can be adjusted for an intrinsic moment. The lifting moment is particularly preferably adjusted for the intrinsic moment if the load moment is known and/or has been determined for example via a deformation analysis (for example of the deflection and/or by reference to a deflection of at least a part of the hoist). For example, the load moment can be ascertained by virtue of lifting moment changes in combination with movement specifications of the hoist (detection of typical lifting and depositing processes in the case of movement and maneuvering of the load mass and/or recognition of typical working cycles. The intrinsic moment can be computed by reducing the lifting moment by the load moment in order to determine the extension length via the intrinsic moment indirectly using the virtual extension lengths. This physical model is particularly precise, can be used both in the case of dynamic and in the case of static loads on the hoist, requires no additional sensor system and can be applied particularly flexibly in different designs/embodiments of hoists, wherein quality values/quality classes can be dependent on an angular position, deflections, load masses, hysteresis seal frictions of lifting cylinders and the like.

Furthermore, preferably the at least one telescopic push arm comprises a cable guide roller, and the at least one parameter in the form of a rotational speed of the cable guide roller is ascertained by the at least one first or the at least one further sensor. The indirect determination of the cable drum movement is preferably used if no sensor of its own such as a rotary encoder for determining the winch speed is available. In the case of a rotary encoder, a residual cable length can also be ascertained, which is relevant for the determination of the number of cable positions on the cable drum in order to be able to deduce a change in cable length from a winch speed (via the unwinding diameter).

A sensor system, which detects a rotational movement of the cable guide roller, from which a change in length can be calculated, can be integrated in a roller head. The sensor system can be formed in the form of an incremental encoder. If an actuation is effected parallel to a telescopic push arm, a change in cable length must be compensated for, wherein for example a volumetric flow rate model can be used for a hydraulic motor of a cable winch and/or control characteristic curves of slide valves. A rotary encoder can for example determine a residual cable length.

A load cable is here repurposed as an indirect measuring cable, if a rotation of a cable drum is compensated for, and can efficiently continuously deliver conclusions for the extension length. Quality-reducing effects such as slackening of the cable or inaccuracies in a parallel operation with telescoping movements can be taken into consideration in the weighting and/or in quality classes/quality values.

In a further embodiment of the invention, at least one, preferably precisely one, virtual extension length is chosen from a plurality of virtual extension lengths manually or automatically, preferably by virtue of a history of at least one virtual extension length, and is used as the first virtual extension length or as the at least one further virtual extension length.

According to an advantageous design of the invention, the first virtual extension length and/or the at least one further virtual extension length is weighted and the chosen virtual extension length is the one with the highest weighting, and/or the first virtual extension length and/or the at least one further virtual extension length is classified into quality classes and/or by a quality value and the chosen virtual extension length is the one with the highest quality class and/or highest quality value.

It can thereby be made possible that the extension length is ascertained using reliable virtual extension lengths and virtual extension lengths of lower weighting, quality class and/or quality value are possibly dispensed with or are also included in the calculation to a limited extent.

According to a preferred embodiment of the invention, a plurality of virtual extension lengths, preferably for minimizing a possibly present margin of error, are combined to ascertain the extension length. Preferably, the first virtual extension length and/or the at least one further virtual extension length is weighted and the plurality of virtual extension lengths are combined taking into account the respective weighting, and/or the first virtual extension length and/or the at least one further virtual extension length is classified into quality classes and/or by a quality value, and the plurality of virtual extension lengths are combined taking into account the respective quality class and/or quality value.

The more virtual extension lengths are used for ascertaining the extension length, the more accurately the extension length can be determined and the margin of error of the extension length can be statistically reduced. However, a selection can generally also be made from a plurality of virtual extension lengths. The virtual extension lengths with higher quality classes and/or weightings are preferably used for the calculation of the—exactly one—extension length.

An advantageous variant is that at least one reference value of an extension length, preferably of a known extension length and/or of an extension length ascertained indirectly or directly by an additional sensor, is provided, with which the at least one first virtual extension length, the at least one further virtual extension length and/or the extension length is replaced by the at least one reference value or brought closer to the at least one reference value, preferably in a time-discrete or time-continuous manner. Preferably, the at least one reference value is given by an end position of the at least one telescopic push arm and/or of the telescopic jib.

As a constant progression can be essential for the further use of the extension length, replacing with respect to the extension length in this context means a continuous transition in the direction of the reference value as a correction of the extension length.

The at least one reference value can be defined, for example, on the basis of a sensor (such as the detection of an operating state—e.g. all telescopic push arms are retracted) and/or an implicit determination (such as a detection of a transport position of the hoist—e.g. by reference to a geometry or a transport position sensor). A switching process of a switch position sensor, which detects a particular telescopic push arm in order to delimit or increase for example the lifting moment and to ensure that a particular radius is not exceeded, represents a further example of the at least one reference value.

It is particularly preferred that the at least one reference value is present in the form of a virtual extension length. The virtual extension length is ascertained in a time-discrete manner by the at least one first sensor or the at least one further sensor.

In an embodiment of the invention, the at least one first virtual extension length is ascertained in a time-discrete manner and the at least one further virtual extension length is ascertained in a time-continuous manner, or vice versa. A difference between the two virtual extension lengths is calculated, preferably in a time-continuous or time-discrete manner, and is stored in a buffer of a control and/or regulating apparatus.

The buffer and/or reference values serve to increase the precision of the extension length during operation of the hoist.

According to a preferred embodiment of the invention:
the difference is weighted, preferably via possibly present quality classes, quality values and/or weightings of the two virtual extension lengths, and/or
the virtual extension length ascertained in a time-continuous and/or time-discrete manner is corrected by the buffer or a part of the buffer, preferably taking into consideration limiting parameters and/or the buffer.

The correction of the virtual extension length is particularly preferably effected in a constant manner, with the result that the extension length is likewise constantly available.

The virtual extension lengths and/or the extension length can be adjusted dynamically and possibly taking into consideration buffer values during operation of the hoist, preferably of the telescopic jib, by temperature, viscosity and wear compensation, wherein the buffer value is preferably emptied successively in the direction of 0. A buffer emptying is preferably effected when a telescoping movement is stopped, wherein the extension length and/or virtual extension lengths are conclusively adapted, in order that in the case of a renewed telescoping movement there is an empty buffer, which can then be filled again via a difference of virtual extension lengths in order to be able to generate a constant and precise signal taking into account a plurality of virtual extension lengths.

A calibration, which is not necessarily connected to the buffer, can preferably be effected, wherein operating parameters, influencing variables and/or parameters can be adapted, preferably dynamically, for adjustment during operation of the hoist.

A calibration can be effected for example by a setting process, a testing process or the like, preferably before operation of the hoist. An adaptation separate from a calibration can represent for example a, preferably dynamic, adjustment of parameters and/or operating parameters, preferably during operation of the hoist—for example for, in particular permanent, wear compensation. The calibration and adaptation can generally change parameters and/or operating parameters which can be connected to the calibration and/or the adaptation.

It has proved to be favorable that the extension length of a part of the telescopic jib or the extension length of the telescopic jib is determined and/or ascertained using the extension length of at least one telescopic push arm.

For example, a plurality of extension lengths of the individual telescopic push arms can be accumulated into a total length of the telescopic push arms. It is also conceivable that the extension length of individual telescopic push arms is already known. Mechanical extensions which have a known extension length can optionally be used for example in the hoist.

According to an advantageous design of the invention, at least one storage unit is provided, which is in or can be brought into data connection with the at least one control and/or regulating apparatus. At least one algorithm for, preferably time-discrete or time-continuous, determination and/or calculation of an extension length via at least one first virtual extension length and at least one further virtual extension length is stored in the at least one storage unit, wherein it is preferably provided that:
the at least one first virtual extension length, the at least one further virtual extension length and/or the extension length can be provided with a quality class, a quality value and/or a weighting by the algorithm, and/or
a buffer can be filled by the algorithm via a difference of the at least one first virtual extension length and the at least one further virtual extension length, wherein the extension length and/or a time-continuous virtual extension length can be adjusted via the buffer using reference values or time-discrete virtual extension lengths, and/or
at least one visualization device is provided, via which the at least one first virtual extension length, the at least one further virtual extension length and/or the extension length can be visualized.

The virtual extension lengths and/or the extension length can be further used with respect to further calculations and/or for application for functions of the hoist such as convenience functions.

The features of the method claims are applicable to the device claims, and vice versa.

### BRIEF DESCRIPTION OF THE DRAWINGS

Further details and advantages of the present invention are explained in more detail below with the aid of the description of the embodiments represented in the drawings, in which:

FIG. 1 shows a hoist according to a preferred embodiment for carrying out a method for indirectly determining an extension length, represented schematically in a view from the side,

FIG. 2 shows a schematically represented hoist for illustrating virtual extension lengths and the extension length of a telescopic jib, ascertained using a method for indirectly determining the extension length.

### DETAILED DESCRIPTION OF THE INVENTION

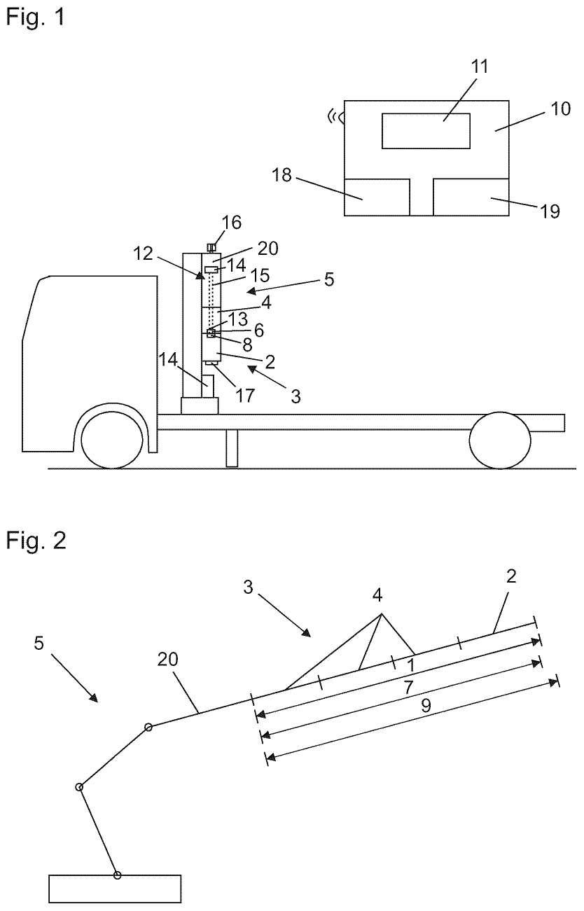

FIG. 1 shows a hoist 5, comprising a telescopic push arm 2 of a telescopic jib 3, a first sensor 6, which does not represent a direct extension length sensor, and a further sensor 8, which does not represent a direct extension length sensor, wherein the further sensor 8 is not strictly necessary, if the first sensor 6 makes the parameters for at least two virtual extension lengths 7, 9 possible on the basis of different physical models via sensor signals. However, the different physical models can for all intents and purposes relate for example to a flow behavior or pressure behavior of hydraulic oil. The location and design of the first sensor 6 and of the further sensor 8 are generally as desired.

The hoist 5 comprises a control and/or regulating apparatus 10, which is in data-transmitting connection with the hoist 5, wherein the connection can be formed wired or transmitting radio signals. The control and/or regulating apparatus 10 is formed to carry out a method for indirectly determining an extension length 1. For this, a computer program product is used which comprises commands which, when executed by a computing unit 18, prompt the latter to perform the method from a storage unit 19 which is in or can be brought into data connection with the computing unit 18.

An algorithm for time-discrete and/or time-continuous determination of the extension length 1 via a first virtual extension length 7 and a further virtual extension length 9 is stored to the storage unit 19, which is in data connection with the control and/or regulating apparatus 10, wherein the number of further virtual extension lengths 9 is generally as desired. The first virtual extension length 7, the further virtual extension length 9 and the extension length 1 can be provided with a quality class, a quality value and a weighting by the algorithm. A buffer can be filled by the algorithm via a difference of the first virtual extension length 7 and the further virtual extension length 9, wherein the extension length 1 and a time-continuous virtual extension length 7, 9 can be adjusted via the buffer using reference values or time-discrete virtual extension lengths 7, 9. A visualization device 11 is provided, via which the first virtual extension length 7, the further virtual extension length 9 and the extension length 1 can be visualized.

The method for indirectly determining the extension length 1 of the telescopic push arm 2 of the telescopic jib 3 relative to a further telescopic push arm 4 or to a main arm 20 as an articulated arm or crane boom of the telescopic jib 3 or of a part of the telescopic jib 3 can be carried out by way of example as follows:
the first sensor 6 ascertains a first parameter of the telescopic push arm 2 over a time interval, wherein a first virtual extension length 7 is calculated via the first parameter via a physical model,
the further sensor 8 ascertains a further parameter of the telescopic push arm 2 over a time interval, wherein a further virtual extension length 9 is calculated via the further parameter via a physical model,
the extension length 1 of the telescopic jib 3 is calculated using the first virtual extension length 7 and the further virtual extension length 9.

The first virtual extension length 7 and the further virtual extension length 9 are weighted, wherein the weighting
is present in the form of a predefined static weighting value and
is determined via a history of the first virtual extension length 7 and the further virtual extension length 9 and
can be calculated by a statistical evaluation of the first virtual extension length 7 and the further virtual extension length 9, wherein the weighting can be changed in dependence on weighting parameters, a quality class or a quality value of the first virtual extension length 7 and the further virtual extension length 9.

In this case, the following criteria are taken into consideration in the weighting: a hoist type, an embodiment of the telescopic jib 3, a number of telescopic push arms 2 and telescopic jibs 3, a type of the first sensor 6 and of the further sensor 8, a type of the first parameter and of the further parameter, a number of parameters used, a current operating position of the telescopic jib 3, requirements placed on the extension length 1, intended use of the extension length 1, operating parameters of the hoist 5. The weighting is adjusted dynamically in each sampling cycle of the mobile control and/or regulating apparatus 10 during operation of the hoist 5 or of the telescopic jib 3.

The first virtual extension length 7 and the further virtual extension length 9 are classified into quality classes or by a quality value, wherein a quality class and a quality value of the extension length 1 are determined. The quality class and the quality value are adjusted dynamically in each sampling cycle of the mobile control and/or regulating apparatus 10 during operation of the hoist 5 or of the telescopic jib 3, wherein the quality class and the quality value
of the first virtual extension length 7 and of the further virtual extension length 9 are adjusted in dependence on the following criteria: an operating position of the telescopic jib 3, a weighting, a history of a hoist movement, a duration of a telescoping movement, further hoist movements, operating parameters of the hoist 5, and
of the extension length 1 are adjusted in dependence on the quality class or the quality value of the first virtual extension length 7 and on the quality class or the quality value of the further virtual extension length 9.

A margin of error taking into consideration a weighting is calculated for the first virtual extension length 7, the further virtual extension length 9 and the extension length 1. The first virtual extension length 7, the further virtual extension length 9 and the extension length 1 together with the margin of error are visualized via a visualization device 11. The first virtual extension length 7, the further virtual extension length 9 and the extension length 1 are determined in a time-continuous or time-discrete manner in dependence on the underlying parameter or the physical model, wherein in no working cycle of the hoist 5 is the extension length 1 calculated exclusively via the first virtual extension length 7.

The first virtual extension length 7, the further virtual extension length 9 and the extension length 1 are calculated taking into consideration the following additional parameters: a telescopic jib geometry, a hoist geometry, an operating position of the telescopic jib 3, a load mass arranged on the telescopic jib 3, an operating parameter of the hoist 5, a history of a hoist movement, a current hoist movement, operating states of hydraulic consumers of the hoist 5, a duration of a telescoping movement. However, the choice of the additional parameters is generally as desired.

The telescopic push arm 2 has a hydraulic drive unit 12 with a diaphragm 13 as a slide valve rod, wherein the diaphragm 13 comprises a plurality of diaphragm positions for controlling a hydraulic oil flow in the hydraulic drive unit 12. The parameter in the form of a current diaphragm position can be ascertained by the first sensor 6 (or the further sensor 8—in the following reference is made only to the first sensor 6), wherein a volumetric flow rate in the hydraulic drive unit 12 can be deduced using the parameter via a physical model.

As the hoist is equipped with a position-dependent diaphragm 13, a flow of hydraulic oil in the hydraulic drive unit 12 can be controlled via the diaphragm 13, wherein parameters in the form of a position of the diaphragm 13 and a pressure difference at the diaphragm 13 are ascertained by the first sensor 6, wherein a volumetric flow rate in the hydraulic drive unit 12 for calculating the first virtual extension length 7 is deduced using the parameters via a physical model.

The hydraulic drive unit 12 comprises a hydraulic oil tank 14 for supplying hydraulic oil to the hydraulic drive unit 12, wherein the parameter in the form of a fill level of the hydraulic oil tank 14 is ascertained by the first sensor 6. Further hydraulic drive units 12 (not visible in the representation for reasons of clarity) connected to the hydraulic oil tank 14 can be taken into consideration via a physical model. Usually only one hydraulic oil tank 14 is arranged next to the crane column for supplying to the hydraulic system, wherein the hydraulic oil tank 14 of the embodiment adjacent to the piston cylinder unit 15 can be dispensed with.

The hydraulic drive unit 12 of the hoist 5 has a piston cylinder unit 15, wherein the parameter in the form of a natural frequency of the telescopic jib 3 at the piston cylinder unit 15 is ascertained by the first sensor 6 via a physical model.

The parameter in the form of an oscillation amplitude of the telescopic jib 3 at the piston cylinder unit 15 can be ascertained by the first sensor 6 via a physical model. The first sensor 6 can generally have a plurality of sensor system modules. The number of sensors 6, 8 is generally as desired and can be matched to the specific parameters to be ascertained.

The parameter in the form of an extreme value of a pressure in the piston cylinder unit 15 is ascertained via the first sensor 6 via an underlying physical model for determining the extreme value. In addition, the physical model makes it possible to determine the further virtual extension length 9 taking into account the parameter.

The parameter in the form of a lifting moment is ascertained by the first sensor 6 via a physical model including load moments and intrinsic moments in the calculation for determining the extension length 1.

The telescopic jib 3 comprises a cable guide roller 16, wherein the parameter in the form of a rotational speed of the cable guide roller 16 is ascertained by the first sensor 6, wherein the rotational speed is used to calculate a further virtual extension length 9 in dependence on any telescoping movements.

The hoist 5 represented is capable of generating virtual extension lengths 7, 9 with all seven underlying physical models described, wherein the hoist 5 is not limited to the number or type of the physical models. For example, hoists 5 can use only two physical models for indirectly ascertaining the extension length 1 via two virtual extension lengths 7, 9, wherein the sensor system used for this can also be designed only for these virtual extension lengths 7, 9 used.

FIG. 2 shows a hoist 5 in the form of a crane, wherein a crane base comprises an articulated system, on which a main arm 20 is arranged as an articulated arm or crane boom. A plurality of telescopic push arms 2, 4 can be telescoped from the main arm 20, wherein the extension length 1 and the virtual extension lengths 7, 9 can generally also be based on a portion of the telescopic jib 3. The extension length 1 of a part of the telescopic jib 3 and the extension length 1 of the entire telescopic jib 3 can be determined using the extension length 1 of individual telescopic push arms 2 of the telescopic jib 3, if there is information about the further telescopic push arms 4.

Precisely one virtual extension length 7, 9 is automatically chosen from a plurality of virtual extension lengths 7, 9 by virtue of a history of a virtual extension length 7, 9 and used as the first virtual extension length 7. The first virtual extension length 7 and the further virtual extension length 9 (only one further virtual extension length 9 is visible in the representation for reasons of clarity) are weighted and classified, and the virtual extension length 7, 9 with the highest weighting or the highest quality class/quality value is chosen. This selection is also applicable to a portion of the virtual extension lengths 7, 9. To minimize a margin of error, a plurality of virtual extension lengths 7, 9 are combined for ascertaining the extension length 1, wherein the first virtual extension length 7 and the further virtual extension length 9 are weighted and the plurality of virtual extension lengths 7, 9 are combined taking into account the respective weighting. The first virtual extension length 7 and the further virtual extension length 9 are classified into quality classes and by a quality value, and the plurality of virtual extension lengths 7, 9 are combined taking into account the respective quality class and quality value.

Reference values in the form of an extension length 1 of a known extension length 1 and an extension length 1 ascertained by an additional sensor 17 are provided, with which the first virtual extension length 7, the further virtual extension length 9 and the extension length 1 are brought closer to the reference values in a time-continuous manner, wherein a reference value is given by an end position of the telescopic jib 3. A reference value is present in the form of a virtual extension length 7, wherein this virtual extension length 7 is ascertained by the first sensor 6 in a time-discrete manner.

A further virtual extension length 9 is, in contrast, ascertained in a time-continuous manner, wherein a difference between the two virtual extension lengths 7, 9 is calculated and is stored in a buffer of the control and/or regulating apparatus 10. The difference can be weighted via quality classes, quality values and weightings of the two virtual extension lengths 7, 9. The virtual extension length 7, 9 ascertained in a time-continuous manner is corrected by the buffer taking into consideration limiting parameters-such as maximum speed change, calculation results of preceding telescoping movements as boundary conditions or the like.

1. A method for indirectly determining an extension length of at least one telescopic push arm of a telescopic jib relative to a further telescopic push arm or to a main arm of the telescopic jib, in particular at least part of the telescopic jib, of a hoist, comprising the following method steps:
at least one first sensor, which is different from a possibly present direct extension length sensor, ascertains at least one first parameter of the at least one telescopic push arm and/or telescopic jib, in particular over a time interval, wherein a first virtual extension length is determined and/or calculated via the at least one first parameter, preferably via a physical model,
the at least one first sensor and/or at least one further sensor, which is different from a possibly present direct extension length sensor, ascertains at least one further parameter of the at least one telescopic push arm and/or telescopic jib, in particular over a time interval, wherein at least one further virtual extension length is determined and/or calculated via the at least one further parameter, preferably via a physical model,
the extension length of the at least one telescopic push arm or of the telescopic jib is determined and/or calculated by the first virtual extension length and the at least one further virtual extension length.

2. The method according to claim 1, wherein the first virtual extension length and/or the at least one further virtual extension length is weighted, preferably wherein the weighting
is present in the form of a predefined static weighting value, and/or
is determined and/or calculated via a history of the first virtual extension length and/or the at least one further virtual extension length, and/or
is determined and/or calculated by a statistical evaluation of the first virtual extension length and/or the at least one further virtual extension length, and/or
is determined and/or calculated in dependence on a quality class and/or a quality value of the first virtual extension length and/or the at least one further virtual extension length, and/or
is determined and/or calculated in dependence on a predefined and/or definable weighting parameter.

3. The method according to claim 2, wherein at least one of the following criteria is taken into consideration in the weighting: a hoist type, an embodiment of the telescopic jib, a number of telescopic push arms and/or telescopic jibs, a type of the at least one first sensor and/or of the at least one further sensor, a type of the at least one first parameter and/or of the at least one further parameter, a number of parameters used, a current operating position of the telescopic jib, requirements placed on the extension length, intended use of the extension length, operating parameters of the hoist.

4. The method according to claim 2, wherein the weighting is adjusted during operation of the hoist, preferably of the telescopic jib and/or dynamically in each sampling cycle of a, preferably mobile, control and/or regulating apparatus.

5. The method according to claim 1, wherein the first virtual extension length and/or the at least one further virtual extension length is classified, preferably into quality classes and/or by a quality value, wherein it is preferably provided that a quality class and/or a quality value of the extension length is determined and/or calculated.

6. The method according to claim 5, wherein the quality class and/or the quality value is adjusted during operation of the hoist, preferably of the telescopic jib and/or dynamically in each sampling cycle of a, preferably mobile, control and/or regulating apparatus, wherein it is preferably provided that the quality class and/or the quality value
of the first virtual extension length and/or of the at least one further virtual extension length is adjusted in dependence on at least one of the following criteria: an operating position of the telescopic jib, a possibly present weighting, a history of a hoist movement, a duration of a telescoping movement, further hoist movements, operating parameters of the hoist, and/or
of the extension length is adjusted in dependence on, preferably the quality class and/or the quality value of, the first virtual extension length and/or on, preferably the quality class and/or the quality value of, the at least one further virtual extension length.

7. The method according to claim 1, wherein at least one margin of error, preferably taking into consideration a possibly present weighting, is determined and/or calculated for the first virtual extension length, the at least one further virtual extension length and/or the extension length.

8. The method according to claim 1, wherein the first virtual extension length, the at least one further virtual extension length and/or the extension length, preferably together with at least one possibly present margin of error, are visualized via a visualization device.

9. The method according to claim 1, wherein the first virtual extension length, the at least one further virtual extension length and/or the extension length is determined and/or calculated in a substantially time-continuous or time-discrete manner.

10. The method according to claim 1, wherein in no working cycle of the hoist and/or at no time is the extension length determined and/or calculated exclusively via the first virtual extension length.

11. The method according to claim 1, wherein the first virtual extension length, the at least one further virtual extension length and/or the extension length is determined and/or calculated taking into consideration at least one additional parameter, preferably at least one of the following additional parameters: a telescopic jib geometry, a hoist geometry, an operating position of the telescopic jib, a load mass arranged on the telescopic jib, an operating parameter of the hoist, a history of a hoist movement, a current hoist movement, operating states of hydraulic consumers of the hoist, a duration of a telescoping movement.

12. The method according to claim 1, wherein the at least one telescopic push arm comprises a hydraulic drive unit with at least one diaphragm, wherein the at least one diaphragm comprises a plurality of diaphragm positions for controlling a hydraulic oil flow in the hydraulic drive unit, wherein the at least one parameter in the form of a current diaphragm position is ascertained by the at least one first or the at least one further sensor, wherein a volumetric flow rate in the hydraulic drive unit is deduced using the at least one parameter, preferably via a physical model.

13. The method according to claim 1, wherein the at least one telescopic push arm comprises a hydraulic drive unit with at least one position-dependent diaphragm, wherein a flow of hydraulic oil in the hydraulic drive unit can be controlled via the at least one diaphragm, wherein the at least one parameter in the form of a position of the at least one diaphragm and/or a pressure difference at the at least one diaphragm is ascertained by the at least one first or the at least one further sensor, wherein a volumetric flow rate in the hydraulic drive unit is deduced using the at least one parameter, preferably via a physical model.

14. The method according to claim 1, wherein the at least one telescopic push arm comprises a hydraulic drive unit with a hydraulic oil tank for supplying hydraulic oil to the hydraulic drive unit, wherein the at least one parameter in the form of a fill level of the hydraulic oil tank is ascertained by the at least one first or the at least one further sensor, wherein it is preferably provided that further hydraulic drive units connected to the hydraulic oil tank are taken into consideration, preferably via a physical model.

15. The method according to claim 1, wherein the at least one telescopic push arm comprises a hydraulic drive unit with a piston cylinder unit, wherein the at least one parameter in the form of a natural frequency of the at least one telescopic push arm and/or of the telescopic jib is ascertained on the piston cylinder unit, preferably via a physical model, by the at least one first or the at least one further sensor.

16. The method according to claim 1, wherein the at least one telescopic push arm comprises a hydraulic drive unit with a piston cylinder unit, wherein the at least one parameter in the form of an oscillation amplitude of the at least one telescopic push arm and/or of the telescopic jib is ascertained on the piston cylinder unit, preferably via a physical model, by the at least one first or the at least one further sensor.

17. The method according to claim 1, wherein the at least one telescopic push arm comprises a hydraulic drive unit with a piston cylinder unit, wherein the at least one parameter in the form of an extreme value of a pressure in the piston cylinder unit is ascertained by the at least one first or the at least one further sensor, preferably via a physical model.

18. The method according to claim 1, wherein the at least one parameter in the form of a lifting moment is ascertained by the at least one first or the at least one further sensor, preferably via a physical model.

19. The method according to claim 1, wherein the at least one telescopic push arm comprises a cable guide roller, wherein the at least one parameter in the form of a rotational speed of the cable guide roller is ascertained by the at least one first or the at least one further sensor.

20. The method according to claim 1, wherein at least one, preferably precisely one, virtual extension length is chosen from a plurality of virtual extension lengths manually or automatically, preferably by virtue of a history of at least one virtual extension length, and is used as the first virtual extension length or as the at least one further virtual extension length.

21. The method according to claim 20, wherein the first virtual extension length and/or the at least one further virtual extension length is weighted and the chosen virtual extension length is the one with the highest weighting, and/or the first virtual extension length and/or the at least one further virtual extension length is classified into quality classes and/or by a quality value and the chosen virtual extension length is the one with the highest quality class and/or highest quality value.

22. The method according to claim 1, wherein a plurality of virtual extension lengths, preferably for minimizing a possibly present margin of error, are combined to ascertain the extension length, wherein it is preferably provided that the first virtual extension length and/or the at least one further virtual extension length is weighted and the plurality of virtual extension lengths are combined taking into account the respective weighting, and/or the first virtual extension length and/or the at least one further virtual extension length is classified into quality classes and/or by a quality value and the plurality of virtual extension lengths are combined taking into account the respective quality class and/or quality value.

23. The method according to claim 1, wherein at least one reference value of an extension length, preferably of a known extension length and/or of an extension length ascertained indirectly or directly by an additional sensor, is provided, with which the at least one first virtual extension length, the at least one further virtual extension length and/or the extension length is replaced by the at least one reference value or brought closer to the at least one reference value, preferably in a time-discrete or time-continuous manner, wherein it is preferably provided that the at least one reference value is given by an end position of the at least one telescopic push arm and/or of the telescopic jib.

24. The method according to claim 23, wherein the at least one reference value is present in the form of a virtual extension length, wherein the virtual extension length is ascertained in a time-discrete manner by the at least one first sensor or the at least one further sensor.

25. The method according to claim 1, wherein the at least one first virtual extension length is ascertained in a time-discrete manner and the at least one further virtual extension length is ascertained in a time-continuous manner, or vice versa, wherein a difference between the two virtual extension lengths is calculated, preferably in a time-continuous or time-discrete manner, and is stored in a buffer of a control and/or regulating apparatus.

26. The method according to claim 25, wherein:
the difference is weighted, preferably via possibly present quality classes, quality values and/or weightings of the two virtual extension lengths, and/or
the virtual extension length ascertained in a time-continuous and/or time-discrete manner is corrected by the buffer or a part of the buffer, preferably taking into consideration limiting parameters and/or the buffer.

27. The method according to claim 1, wherein the extension length of a part of the telescopic jib or the extension length of the telescopic jib is determined and/or ascertained using the extension length of at least one telescopic push arm.

28. A computer program product comprising commands which, when executed by a computing unit, prompt the latter to perform a method according to claim 1 from a storage unit which is in or can be brought into data connection with the computing unit.

29. A hoist comprising:
at least one telescopic push arm and/or at least one telescopic jib,
at least one first sensor, which is different from a possibly present direct extension length sensor,
possibly at least one further sensor, which is different from a possibly present direct extension length sensor, and
at least one control and/or regulating apparatus, wherein the control and/or regulating apparatus is formed to carry out a method according to claim 1.

30. The hoist according to claim 29, wherein at least one storage unit is provided, which is in or can be brought into data connection with the at least one control and/or regulating apparatus, wherein at least one algorithm for, preferably time-discrete or time-continuous, determination and/or calculation of an extension length via at least one first virtual extension length and at least one further virtual extension length is stored in the at least one storage unit, wherein it is preferably provided that:
the at least one first virtual extension length, the at least one further virtual extension length and/or the extension length can be provided with a quality class, a quality value and/or a weighting by the algorithm, and/or
a buffer can be filled by the algorithm via a difference of the at least one first virtual extension length and the at least one further virtual extension length, wherein the extension length and/or a time-continuous virtual extension length can be adjusted via the buffer using reference values or time-discrete virtual extension lengths, and/or
at least one visualization device is provided, via which the at least one first virtual extension length, the at least one further virtual extension length and/or the extension length can be visualized.
